(19) United States
(12) Patent Application Publication
(10) Pub. No.: US 2024/0377663 A1
(43) Pub. Date: Nov. 14, 2024

(54) OPTICAL VOLTAGE PROBE

(71) Applicant: SEIKOH GIKEN Co., Ltd., Matsudo-shi (JP)

(72) Inventor: Ryuji OSAWA, Matsudo-shi (JP)

(21) Appl. No.: 18/650,090

(22) Filed: Apr. 30, 2024

(30) Foreign Application Priority Data
May 10, 2023 (JP) 2023-077652

(51) Int. Cl. G02F 1/03; G02F 1/00; G02F 1/035

(52) U.S. Cl. CPC G02F 1/0316; G02F 1/0036; G02F 1/035; G02F 2201/02; G02F 2202/20

(57) ABSTRACT

An optical voltage probe including: an optical modulator 1 having two modulation electrodes 11, 12 configured to modulate an intensity of an incident light depending on a voltage between the two modulation electrodes 11, 12 and output the modulated incident light; an input/output optical fiber 2 connected with the optical modulator 1; two contact terminal attachment portions 5, 6 to which two contact terminals 3, 4 can be detachably attached and contacted, the two contact terminals 3, 4 being connected with the modulation electrodes 11, 12 and in contact with points to be measured; and a package 8 that houses the optical modulator 1 and a part of the input/output optical fiber 2, wherein a voltage signal induced via the contact terminals 3, 4 is converted into an optical intensity modulation signal and outputted, and the package 8 covers an inside with a metal body 8a for shielding electric field and a magnetic shielding material 8b for shielding magnetic field.

### CROSS-REFERENCE TO RELATED APPLICATIONS

This patent specification is based on Japanese patent application, No. 2023-077652 filed on May 10, 2023 in the Japan Patent Office, the entire contents of which are incorporated by reference herein.

### PRIOR ART

[Patent document 1] Japanese Unexamined Patent Application Publication No. S63-196863

[Patent document 2] Japanese Unexamined Patent Application Publication No. H08-35998

[Patent document 3] Japanese Unexamined Patent Application Publication No. 2021-165666

### BACKGROUND OF THE INVENTION

The present invention relates to an optical voltage probe that applies a voltage signal obtained from contact terminals to an optical modulator, converts the voltage signal into an optical modulation signal, and outputs the optical modulation signal through an optical fiber.

In recent years, various control devices using a high speed CPU or the like have been developed and noise signals generated on an electric circuit board or the like of the control devices are detected and noise resistance tests or the like of the electric circuit board or the like are performed as a malfunction preventive countermeasure. In the above described tests, it is required to correctly measure input/output signals of electric components installed on the electric circuit board and electrical signals transmitted through wirings.

As for a general method for measuring the electric signals of the electric components and the wirings, the electric signal of the point to be measured is transferred to a measuring instrument such as an oscilloscope by using an electric probe having contact terminals and a voltage waveform or the like of the transferred electric signals is measured. However, when a ground level of the point to be measured is different from that of the measuring instrument or when the voltage signal between ungrounded two points is measured, it is difficult to measure the voltage waveform correctly because of the influence of the mixture of signals from the ground and the capacity of the electric probe, for example. In particular, the above described influence of the ground and the capacity is large in a high frequency region.

Furthermore, an input impedance and an output impedance are not 50 Ω in many integrated circuits such as IC and LSI. For example, the input impedance is high and the output impedance is low in an amplifier element. Therefore, when the input noise voltage is measured by using the electric probe having a low input impedance, current flows to the electric probe side and the noise voltage to be measured is lowered.

As for the means for solving the above described problem, a measuring instrument using an optical voltage probe has been developed where the voltage signal is converted into an optical signal and the optical signal is transferred to the measuring instrument through an optical fiber. In the above described method, a capacity component of the probe is extremely low. Thus, the input impedance is extremely high and the point to be measured and the measuring instrument are electrically separated from each other completely. The optical voltage probe can measure even high frequency component. Thus, the influence of the ground can be eliminated and the intrusion of the electric signal noise generated midway can be prevented.

Examples of the above described conventional measuring instruments are described in Patent documents 1, 2 and 3.

Patent document 1 describes the optical voltage probe using a bulk type optical modulator. Namely, Patent document 1 describes the configuration that the voltage signal of the contact terminals is applied between two electrodes sandwiching a crystal having an electrooptic effect, an incident light transmitted from an optical fiber is reflected in the crystal to change the polarization state, and the change is converted into a light intensity modulated light through an analyzer, and the light intensity modulated light is transmitted to an O/E converter through the optical fiber.

Patent document 2 describes the optical voltage probe having a waveguide type optical modulator. This obtains an optical intensity modulation signal by applying the voltage signal of the contact terminals between two modulation electrodes of a branch interference type optical modulator formed on a lithium niobate crystal substrate. A device having a light source and an O/E converter is connected with the optical voltage probe through the optical fiber.

Furthermore, in order to prevent an influence of a surrounding electromagnetic wave noise, Patent document 3 describes the configuration of the optical voltage probe where a package is covered with a conductive material such as a metal for shielding an electromagnetic wave and the optical voltage probe where the package is covered with a radio wave absorption material such as a ferrite.

### SUMMARY OF THE INVENTION

As described above, in the conventional optical voltage probe, different from the electric probe, the influence of the ground can be eliminated and the intrusion of the electric signal noise generated midway of the wirings to the measuring instrument can be prevented. Furthermore, the optical voltage probe of Patent document 3 describes that it is possible to eliminate the influence of the electromagnetic wave noise transmitted directly to the modulation electrodes propagating in the space around the optical voltage probe while wirings connecting from the contact terminals to the modulation electrodes function as an antenna by covering the package with the metal or the radio wave absorption material.

However, the inventors of the present invention revealed by the experiment that the influence of the electromagnetic wave noise remained in some cases even when the conventional optical voltage probe with the package for shielding the surrounding electromagnetic wave is used and the reason of that was due to the magnetic field component of the electromagnetic wave noise existing around the optical voltage probe. In general, when an electromagnetic wave is radiated and a wavelength of the electromagnetic wave is λ, there is an area called a near field where the magnetic field and the electric field are separately and complicatedly exist in the region within the distance of λ/2π from the source of discharging the electromagnetic wave. The magnetic field in the near field causes to generate the voltage by electromagnetic induction on a loop-shaped line track including the circuits to be measured and the wirings from the contact terminals to the modulation electrodes. Thus, the generated voltage is superimposed on the voltage of the contact terminals to be measured and the measurement of the correct voltage of the contact terminals is prevented.

The purpose of the present invention is to provide the optical voltage probe capable of solving the above described problem and measuring the voltage signals of the points to be measured correctly without being affected by the magnetic field of the electromagnetic wave noise in the near field.

For solving the above described problems, the first viewpoint of the optical voltage probe of the present invention includes: an optical modulator having at least two modulation electrodes, the optical modulator being configured to modulate an intensity of an incident light depending on a voltage between the two modulation electrodes and output the modulated incident light; an input optical fiber that is connected with the optical modulator; an output optical fiber that is connected with the optical modulator; two contact terminals or two contact terminal attachment portions to which two contact terminals can be detachably attached and contacted, the two contact terminals being connected with the modulation electrodes and configured to be in contact with points to be measured, the two contact terminals being connected with the two modulation electrodes and configured to be in contact with the points to be measured; and a package that houses the optical modulator, a part of the input optical fiber and a part of the output optical fiber, wherein a voltage signal induced between the two modulation electrodes via the contact terminals is converted into an optical intensity modulation signal by the optical modulator and the optical intensity modulation signal is outputted through the output optical fiber, the package is configured to cover an inside with a metal body for shielding an electric field and a magnetic shielding material for shielding a magnetic field, the magnetic shielding material being arranged inside or outside the metal body, and the magnetic shielding material is formed of a layered material or a sheet material having a relative magnetic permeability of 1000 or more.

As described above, in the optical voltage probe of the present invention, since the inside of the package is covered with the metal body having the shielding effect of the magnetic field, the electric field component of the surrounding electromagnetic wave noise at the point to be measured is prevented from being received by the modulation electrodes of the optical modulator or the wirings in the midway to the modulation electrodes. Furthermore, since the inside of the package is covered with the magnetic shielding material having a relative magnetic permeability of 1000 or more, the influence of the magnetic field component of the electromagnetic wave noise in the near field can be also suppressed. Even when the magnetic field exists around the optical voltage probe, a magnetic flux of the magnetic field mainly passes inside the magnetic shielding material having high relative magnetic permeability and covering the package. Thus, the magnetic flux density inside the package is reduced. The above described effect of shielding the magnetic field becomes larger as the relative magnetic permeability of the material to be used becomes larger. In order to obtain the effect sufficiently, the value of the relative magnetic permeability is preferably 1000 or more. Practically, the relative magnetic permeability is preferably 6000 or more and further preferably 10000 or more. The thickness of the magnetic shielding material can be thinner as the relative magnetic permeability of the material increases to obtain the same effect of shielding the magnetic field. Magnetic materials made of permalloy or amorphous alloy having the relative magnetic permeability of approximately 100000 can be used as the magnetic shielding material, for example.

Here, it is enough for the magnetic shielding material covering the inside of the package to prevent the voltage from being generated by the magnetic field in the near field on the loop-shaped line track including the circuits to be measured and the wirings from the contact terminals to the modulation electrodes. Thus, it is not necessary to cover the entire the package. It is enough to arrange the magnetic shielding material so that the magnetic flux enters in the loop-shaped line track is shielded. Namely, it is enough if the magnetic shielding material is arranged to cover the region where the loop-shaped line track is formed.

In the optical voltage probe, the measurement is performed by bringing the contact terminals into contact with the point of the circuit board or the like to be measured. It is possible to provide the contact terminals integrally with the optical voltage probe. Alternatively, it is possible to provide two contact terminal attachment portions on the optical voltage probe so that the contact terminals can be detachably attached and contacted in order to make it possible to select the contact terminals depending on the purpose. Note that the input impedance of the optical voltage probe can be further increased and the influence of the input impedance during the measurement can be suppressed when the interval between the contact terminals or between the contact terminal attachment portions is 3 mm or more.

In the present invention, it is possible to form the package by the metal body for obtaining the shielding effect of the electric field. The shape of the package can be an arbitrary shape as long as the package houses and covers the optical modulator and the wirings from the contact terminals to the modulation electrodes inside the package. Instead of the method of forming the package by processing the metal such as a metal plate, it is also possible to form the package by an insulating resin, ceramic or the like and provide a metal film for covering the entire outer surface or the entire inner surface of the above described material. Various methods can be adopted. For example, a metal film can be vapor-deposited on the surface (outside) of the package, a metal tape can be attached on the surface of the package, and a metal plating, a metal material or the like can be applied on the surface of the package. In addition, it is also possible to form the package by a plate-shaped material having a metal layer inside. Furthermore, the metal body can be a mesh-shaped metal body having holes sufficiently smaller than the wavelength of the electromagnetic wave to be shielded.

The magnetic shielding material can be formed on the surface of the package while the magnetic shielding material can be formed inside the package. As the material shape, in addition to a plate-shaped material made of a permalloy or the like, a sheet-shape material and a coating material commercially available as the magnetic shielding material can be also used.

In the second viewpoint of the present invention, an optical voltage probe of the present invention includes: an optical modulator having at least two modulation electrodes, the optical modulator being configured to modulate an intensity of an incident light depending on a voltage between the two modulation electrodes and output the modulated incident light; an input optical fiber that is connected with the optical modulator; an output optical fiber that is connected with the optical modulator; two contact terminals or two contact terminal attachment portions to which two contact terminals can be detachably attached and contacted, the two contact terminals being connected with the modulation electrodes and configured to be in contact with points to be measured, the two contact terminals being connected with the modulation electrodes and configured to be in contact with the points to be measured; and a package that houses the optical modulator, a part of the input optical fiber and a part of the output optical fiber, wherein a voltage signal induced between the two modulation electrodes via the contact terminals is converted into an optical intensity modulation signal by the optical modulator and the optical intensity modulation signal is outputted through the output optical fiber, and the package is configured to cover an inside with a metal body having a relative magnetic permeability of 1000 or more for shielding an electric field and a magnetic field.

In the invention of the above described viewpoint, the metal body having the relative magnetic permeability of the value of 1000 or more is used for the metal body for shielding the electric field. Thus, the metal body also has the function of the magnetic shielding material for shielding the magnetic field. Accordingly, both the electric field and the magnetic field in the near field of the surrounding electromagnetic wave noise can be shielded. For example, it is possible to form the package by a permalloy plate, which is the magnetic shielding material, or to form the package by the other metal material or the insulating material and covering the package with a permalloy sheet.

In the third viewpoint of the present invention, the optical voltage probe of the first viewpoint is characterized in that an electric wave absorber is provided on a surface of the package for reducing a reflection of an electromagnetic wave arrived from an outside of the package and reflected by the package. In the optical voltage probe of the present invention, since the package having the effect of shielding the electric field and the magnetic field is used, it is possible to prevent the modulation electrodes and the like from directly detecting the surrounding electromagnetic wave noise. However, if the electromagnetic wave noise is reflected by the package arranged near the circuit board or the like to be measured and irradiated on the portion having the function of a reception antenna of the circuit board or the like to be measured, there is a risk that the signal caused by the electromagnetic wave noise may be mixed in the signal measured from the contact terminals. In the invention of the present viewpoint, since the electric wave absorber is provided on the surface of the package, the electromagnetic wave noise is absorbed and the reflection of the electromagnetic wave noise can be reduced. Consequently, the reflected wave of the electromagnetic wave noise reflected from the package arranged near the point to be measured is reduced and the influence of the electromagnetic wave noise in the measurement can be further reduced.

The electric wave absorber used for the invention of the present viewpoint can be anything as long as the electric wave absorber has the function of reducing the reflection of the electric wave. For example, a conductive radio wave absorption material formed by textile or the like of conductive fiber which absorbs the electric current generated by the electric wave by the resistance inside the material, a dielectric radio wave absorption material formed by mixing carbon powder or the like with dielectric materials such as rubber, urethane foam and polystyrene foam for using (increasing) an apparent dielectric loss, and a magnetic radio wave absorption material using nickel, ferrite or the like for absorbing the electric wave by magnetic loss can be used. In addition, the shape of the material can be a sheet-shaped material and a coating-type material, for example.

In the fourth viewpoint of the present invention, the optical voltage probe of the second viewpoint is characterized in that an electric wave absorber is provided on a surface of the package for reducing a reflection of an electromagnetic wave arrived from an outside of the package and reflected by the package.

In the fifth viewpoint of the present invention, the optical voltage probe of the first to fourth viewpoints is characterized in that the optical modulator is a branch interference type optical modulator using an optical waveguide formed on a lithium niobate crystal substrate. The invention of the present viewpoint uses the branch interference type optical modulator achieved by the optical waveguide formed on the lithium niobate crystal substrate although it has been conventionally used as the optical modulator. The branch interference type optical modulator is basically composed of an input optical waveguide extended from a light incident side, two phase shift waveguides extended from the input optical waveguide and branched into two, an output optical waveguide at which the two phase shift optical waveguides are joined and connected to a light emission side, and modulation electrodes arranged in parallel with the two phase shift waveguides. The voltage signal is applied to the phase shift optical waveguides via the modulation electrodes, a refractive index of the phase shift optical waveguides is changed, and the light passing through the two phase shift optical waveguides are joined and interfered with each other. Thus, the optical intensity is modulated. Since a small, high efficient and broadband optical modulator can be obtained, it is suitable for the optical voltage probe of the present invention.

Note that a so-called split electrode (segmented electrode) formed by a plurality of electrodes which are divided in a longitudinal direction and capacitively coupled with each other is used as the modulation electrodes in the present invention. The split electrode formed by dividing one modulation electrode into a plurality of capacitively coupled electrodes is an efficient means for improving the trade-off relation between the length of the modulation electrodes and the electric capacity related to the modulation efficiency and the modulation bandwidth. The high efficient and broadband optical modulator can be obtained by using the split electrode.

In the sixth viewpoint of the present invention, the optical voltage probe of the first to fourth viewpoints is characterized in that the optical modulator is a branch interference type optical modulator using an optical waveguide formed on a lithium niobate crystal substrate, the optical modulator is a reflection type optical modulator where the incident light is reflected inside the optical modulator to change a direction of the incident light, and the input optical fiber and the output optical fiber are formed by one input/output optical fiber. The reflection type optical modulator of the invention of the present viewpoint has the configuration that the incident light is reflected in the phase shift optical waveguide and returned to the optical waveguide of the incident side. When the above described configuration of the reflection type optical modulator is used, the length through which the light is transmitted is twice the length compared to the case where a transmission-type optical modulator having the electrode of the same length is used. Thus, the optical modulator can be more efficient, more broadband and smaller. Furthermore, since the number of the optical fiber connected to the optical modulator is one, handling is facilitated.

As described above, the optical voltage probe capable of measuring the voltage signals of the point to be measured correctly without being affected by the magnetic field of the electromagnetic wave noise in the near field can be obtained by the present invention.

### BRIEF DESCRIPTION OF DRAWINGS

FIGS. 1A to 1D are configuration diagrams schematically showing the configuration of an optical voltage probe concerning the first embodiment. FIG. 1A is a plan view of a transmission-type, FIG. 1B is a side view of the transmission-type, FIG. 1C is a partially enlarged cross-sectional view showing the cross-sectional configuration of a package, and FIG. 1D is a partially enlarged cross-sectional view of a contact terminal attachment portion.

FIG. 2 is a block diagram of a measurement system using the optical voltage probe concerning the first embodiment.

FIGS. 3A and 3B are diagrams schematically showing an example of the configuration of a reflection type optical modulator included in the optical voltage probe of the first embodiment.

FIG. 3A is a plan view and FIG. 3B is an A-A cross-sectional view.

FIGS. 4A and 4B are diagrams schematically showing the configuration of an optical voltage probe concerning the second embodiment. FIG. 4A is a plan view of the transmission-type and FIG. 4B is a partially enlarged cross-sectional view showing the cross-sectional configuration of the package.

FIGS. 5A and 5B are diagrams schematically showing the configuration of an optical voltage probe concerning the third embodiment. FIG. 5A is a plan view of the transmission-type and FIG. 5B is a partially enlarged cross-sectional view showing the cross-sectional configuration of the package.

### DETAILED DESCRIPTION OF THE INVENTION

Hereafter, the optical voltage probe of the present invention will be explained in detail using the embodiments with reference to the drawings. Note that the same reference numerals are added to the same elements in the explanation of the drawings and the repeated explanation will be omitted.

### First Embodiment

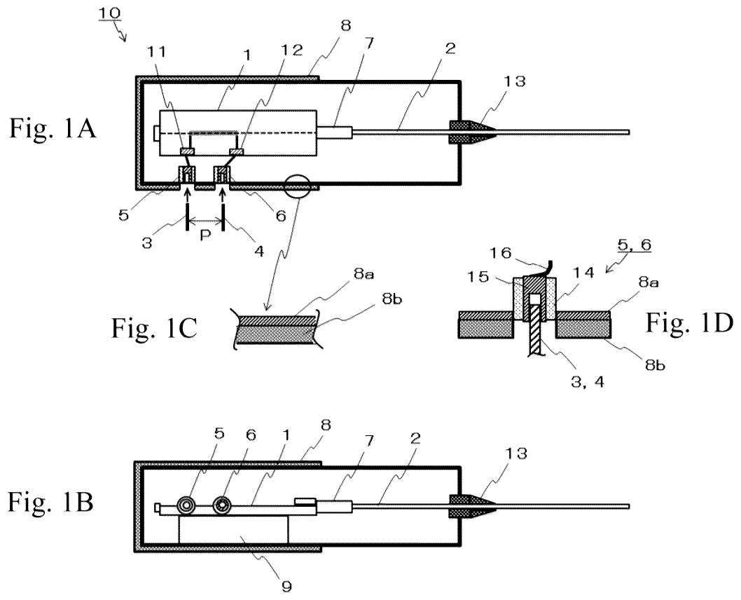

FIGS. 1A to 1D are configuration diagrams schematically showing the configuration of an optical voltage probe concerning the first embodiment. FIG. 1A is a plan view of a transmission-type, FIG. 1B is a side view of the transmission-type, FIG. 1C is a partially enlarged cross-sectional view showing the cross-sectional configuration of the package, and FIG. 1D is a partially enlarged cross-sectional view of the contact terminal attachment portion.

In FIGS. 1A to 1D, an optical voltage probe 10 of the present embodiment includes two modulation electrodes 11 and 12. The optical voltage probe 10 also includes an optical modulator 1 that modulates an intensity of an incident light depending on a voltage between the modulation electrode 11 and the modulation electrode 12. The optical voltage probe 10 also includes an input optical fiber and an output optical fiber that are connected with the optical modulator 1. Furthermore, the optical voltage probe 10 includes contact terminal attachment portions 5 and 6 to which two contact terminals 3 and 4 can be contacted and detachably attached, where the two contact terminals 3 and 4 are configured to be in contact with the point to be measured and the contact terminal attachment portions 5 and 6 are respectively connected with the modulation electrodes 11 and 12. In the present embodiment, the optical modulator 1 is a reflection type optical modulator where the incident light is reflected inside the optical modulator 1 to change a direction of the incident light. The input optical fiber from which the light is inputted in the optical modulator 1 and the output optical fiber to which the light is outputted from the optical modulator 1 are formed by one input/output (input and output) optical fiber 2. The tip of the input/output optical fiber 2 is inserted into a ferrule 7 and fixed so that the end surface of the input/output optical fiber 2 is adhered and fixed with the end surface of the input/output terminal of the optical modulator 1.

In addition, the optical modulator 1 and a part of the input/output optical fiber 2 are housed inside a package 8 which is formed in a rectangular parallelepiped shape. Here, the package 8 is formed by arranging a magnetic shielding material 8b formed of a permalloy sheet for shielding the magnetic field outside a metal plate 8a formed of an aluminium for shielding the electric field. However, the magnetic shielding material 8b does not cover the entire metal plate 8a. The magnetic shielding material 8b is arranged to cover the modulation electrodes and the contact terminal attachment portions 5, 6 of the optical modulator to which the effect of the surrounding magnetic field reaches. Thus, the magnetic shielding material 8b is not arranged on the right half of the package 8 shown in FIGS. 1A and 1B. The optical modulator 1 is fixed to a seat 9 which is fixed to the package 8. The input/output optical fiber 2 is fixed to the package 8 by a rubbery fixing member 13. Here, the effect of shielding the magnetic field can be obtained when the thickness of the permalloy sheet is 0.1 mm or more. As the material of the magnetic shielding material 8b in the present embodiment, magnetic materials of amorphous metal formed of cobalt, zirconium, niobium or the like can be used in addition to the permalloy sheet, for example.

As shown in FIG. 1C, each of the contact terminal attachment portions 5 and 6 is composed of a tubular (cylindrical) insulator 14 and a tubular (cylindrical) terminal insertion portion 15 made of metal and housed inside the insulator 14. When performing the measurement, the contact terminal 3 is inserted into the terminal insertion portion 15 of the contact terminal attachment portion 5 and the contact terminal 4 is inserted into the terminal insertion portion 15 of the contact terminal attachment portion 6. A lead wire 16 is attached to the terminal insertion portion 15 to connect the terminal insertion portion 15 with the modulation electrodes 11 or 12. The insulator 14 is fixed to the package 8. In the present embodiment, the contact terminal attachment portions 5 and 6 are installed inner than a position of a surface of the package 8. In addition, a center interval between the two contact terminal attachment portions 5 and 6 is approximately 5 mm. When the two contact terminals 3 and 4 are attached, an interval P between the two contact terminals 3 and 4 is also approximately 5 mm. As described above, since the interval between the contact terminals is separated from each other by 3 mm or more, high input impedance can be obtained.

Next, the measurement system using the optical voltage probe 10 of the present embodiment will be explained.

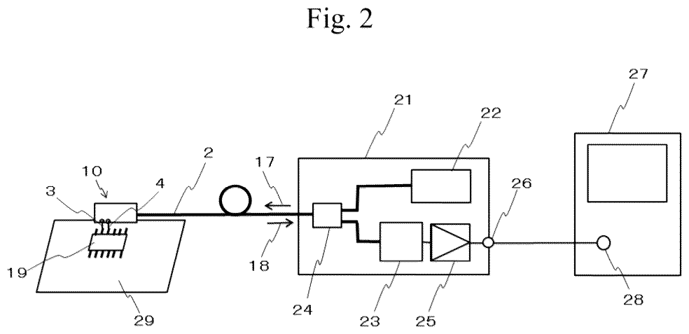

FIG. 2 is a block diagram of a measurement system using the optical voltage probe concerning the first embodiment. As shown in FIG. 2, an incident light 17 is transmitted from an optical transmission/reception unit 21 to the optical voltage probe 10 through the input/output optical fiber 2. An optical intensity modulation signal 18 outputted from the optical modulator 1 is inputted to the optical transmission/reception unit 21 through the same input/output optical fiber 2.

The optical transmission/reception unit 21 includes a light source 22 such as a semiconductor laser, an O/E (Optical/Electrical) converter 23, a transmission/reception separator 24 for separating the incident light 17 from the optical intensity modulation signal 18, and an amplifier 25. An emission light emitted from the light source 22 is coupled into the input/output optical fiber 2 through the transmission/reception separator 24. The optical intensity modulation signal 18 returned from the input/output optical fiber 2 is inputted to the O/E converter 23 through the transmission/reception separator 24. The optical intensity modulation signal 18 is converted into the electric signal in the O/E converter 23, and the electric signal is amplified by the amplifier 25 and output to an output terminal 26. The outputted electric signal is inputted to an input terminal 28 of a measuring instrument 27 such as an oscilloscope. The transmission/reception separator 24 can be formed by one of an optical circulator, an optical fiber splitter and a semi-transparent mirror.

FIG. 2 shows the case where the voltage signal applied between two terminals of an electric component 19 incorporated in an electric circuit board 29 is measured as the point to be measured. The contact terminals 3 and 4 of the optical voltage probe 10 are brought into contact with two terminals of the electric component 19 to be measured. The voltage signal inputted through the contact terminals 3 and 4 is led to the modulation electrodes 11 and 12 and the voltage signal is converted into the optical intensity modulation signal 18 by the optical modulator 1. The optical intensity modulation signal 18 is converted into the electric signal in the optical transmission/reception unit 21. The voltage waveform of the electric signal is observed by the measuring instrument 27, for example. Thus, the waveform of the voltage signal applied between the two terminals of the electric component 19 can be recognized.

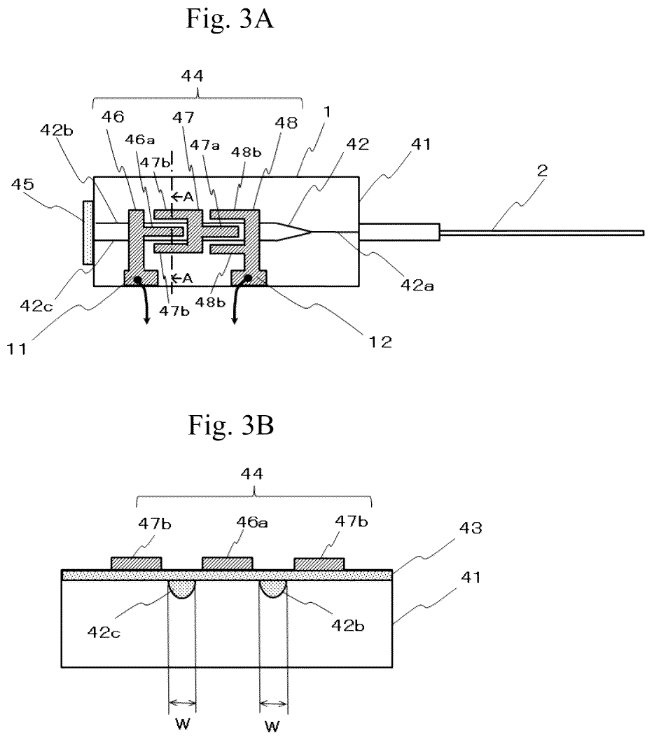

FIGS. 3A and 3B are diagrams schematically showing an example of the configuration of the reflection type optical modulator 1 included in the optical voltage probe 10 of the present embodiment. FIG. 3A is a plan view and FIG. 3B is an A-A cross-sectional view.

In FIGS. 3A and 3B, the optical modulator 1 is composed of: a substrate 41 formed by cutting (X cutting) a lithium niobate (LiNbO₃) crystal which is a crystal having an electrooptic effect; a branch interference type optical waveguide 42 formed on an upper surface side of the substrate 41 by Ti diffusion; a buffer layer 43 coated on an upper surface side of the substrate 41; a modulation electrode portion 44 including the modulation electrodes 11 and 12 coated on the buffer layer 43; and a light reflecting portion 45 provided on one of end portions of the substrate 41. The modulation electrode portion 44 is a two-layered film of chrome (Cr) and aurum (Au) formed by sputtering or the like.

The branch interference type optical waveguide 42 is composed of: an input/output optical waveguide 42a extending toward the direction from which the input (incident) light is inputted; and two phase shift optical waveguides 42b, 42c extended from the input/output optical waveguide 42a and branched into two. In the input/output optical waveguide 42a and the phase shift optical waveguides 42b, 42c, the widths W, which are vertical to the direction of extending the waveguides 42a, 42b and 42c, are within the range of 5 to 12 μm and are equal to each other. In addition, the lengths of the phase shift optical waveguides 42b, 42c in the extending direction are within the range of 10 to 30 mm and are approximately equal to each other. The phase shift optical waveguides 42b, 42c are separated from each other and extended in parallel to each other so that the center parts of them are separated by the range of 15 to 50 μm. The buffer layer 43 is provided for the purpose of preventing a part of the light propagating through the optical waveguides 42 from being absorbed by the modulation electrode portion 44. The buffer layer 43 is mainly made of silica (SiO₂) film or the like and the thickness of the buffer layer 43 is approximately 0.1 to 1.0 μm.

In the optical modulator 1, the modulation electrode portion 44 is composed of split electrodes formed by three electrodes 46, 47, 48 which are divided from each other in a longitudinal direction of the branch interference type optical waveguide 42 and capacitively coupled with each other. The electrode 46 is a part of the modulation electrode 11 and an electrode portion 46a arranged between the phase shift optical waveguide 42b and the phase shift optical waveguide 42c is provided. The electrode 47 includes: electrode portions 47b arranged on both sides of the electrode portion 46a to sandwich the phase shift optical waveguides 42b, 42c; and an electrode portion 47a arranged between the phase shift optical waveguides 42b, 42c. The electrode 48 is a part of the modulation electrode 12 and the electrode 48 includes an electrode portion 48b arranged on both sides of the electrode portion 47a to sandwich the phase shift optical waveguides 42b, 42c. Between the modulation electrodes 11 and 12, the electrodes 46, 47 and the electrodes 47, 48 are capacitively coupled with each other and arranged in series.

The input/output terminal of the input/output optical fiber 2 is coupled with the light input/output end of the input/output optical waveguide 42a of the substrate 41. The light reflecting portion 45 reflects the light incident from the input/output optical waveguide 42a and propagated through the phase shift optical waveguides 42b, 42c to return the light and make the light propagate from the phase shift optical waveguides 42b, 42c to the input/output optical waveguide 42a. When the voltage is applied between the modulation electrodes 11 and 12, an electric field is applied to the two phase shift optical waveguides 42b, 42c (i.e., between the electrode portions 46a and 47b and between the electrode portion 47a and 48b) in an opposite direction to each other. Consequently, the refractive index change occurs in the phase shift optical waveguides 42b, 42c in an opposite direction to each other. Thus, a phase shift having polarity opposite to each other is made in the light passing through the phase shift optical waveguides 42b, 42c. The intensity change occurs when the lights are joined since the lights are interfered with each other. Consequently, the optical intensity modulation signal having the light intensity change depending on the voltage applied between the modulation electrodes 11 and 12 can be obtained.

An immunity test of the electric circuit board was performed by using the optical voltage probe of the present embodiment. A predetermined electromagnetic wave noise was generated from a test device and the signal waveform was measured at a predetermined position in the electric circuit board. When the conventional optical voltage probe without the magnetic shielding material was used, the signal waveform was detected while being overwrapped with the test waveform of the immunity test. When the optical voltage probe of the present embodiment with the magnetic shielding material was used, only the signal waveform of the electric circuit could be detected. Namely, it was confirmed that the voltage signal of the point to be measured could be correctly measured without being affected by the electric field of the near field of the surrounding electromagnetic wave noise.

### Second Embodiment

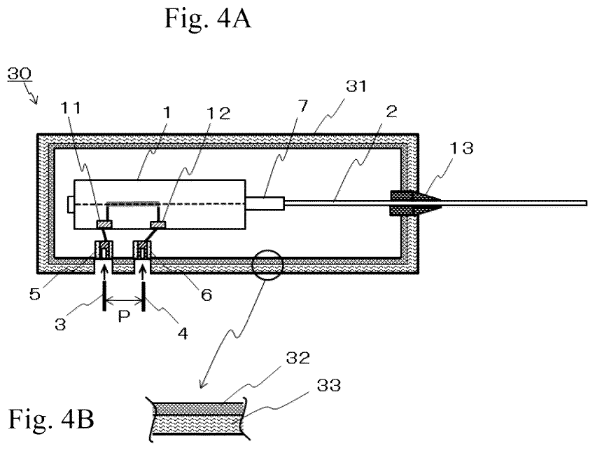

FIGS. 4A and 4B are diagrams schematically showing the configuration of an optical voltage probe concerning the second embodiment. FIG. 4A is a plan view of the transmission-type and FIG. 4B is a partially enlarged cross-sectional view showing the cross-sectional configuration of the package. As shown in FIGS. 4A and 4B, in an optical voltage probe 30 of the second embodiment, the optical modulator 1 similar to that of the first embodiment is arranged and fixed in a package 31. The optical voltage probe 30 is same as the optical voltage probe 10 of the first embodiment except for the package 31. In the present embodiment, the package 31 includes: a metal body 32 formed of a permalloy plate having the relative magnetic permeability of approximately 100000 for shielding the electric field and the magnetic field; and a sheet-shaped electric wave absorber 33 arranged on the outside of the metal body 32 for reducing the reflection of the electromagnetic wave arrived from the outside of the package 31 and reflected by the package 31.

Here, the shape of the metal body 32 is same as the shape of the metal body 8a of the first embodiment. The electric wave absorber 33 is a sheet made of a dielectric radio wave absorption material formed by mixing carbon powder or the like with dielectric materials such as rubber, urethane foam and polystyrene foam for increasing an apparent dielectric loss. The electric wave absorber 33 is adhered to an exposed surface of the contact terminal attachment portions 5 and 6 of the metal package 32 and an entire surface of the input/output optical fiber 2 except for the fixing member 13.

In the present embodiment, the voltage signal of the point to be measured can be correctly measured without being affected by the electric field of the near field of the electromagnetic wave noise. Furthermore, the reflection of the electromagnetic wave noise of the package 31 arranged near the point to be measured and reflected by the metal body 32 can be reduced by the electric wave absorber 33. Thus, the inclusion of noise into the circuit to be measured is prevented and the influence of the electromagnetic wave noise in the measurement can be further reduced. In addition, since it can be formed only by adhering the sheet of the electric wave absorber on the surface, the manufacturing process can be simplified.

### Third Embodiment

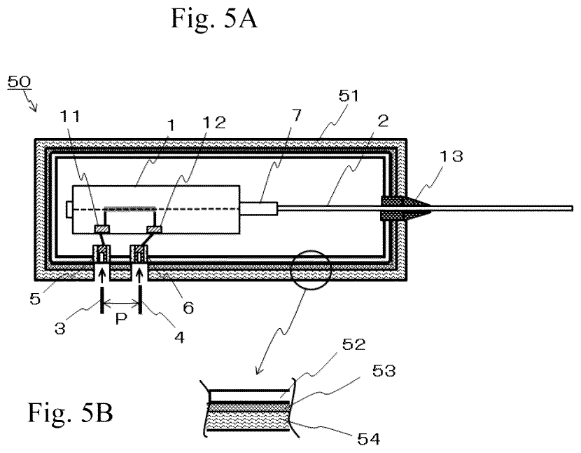

FIGS. 5A and 5B are diagrams schematically showing the configuration of an optical voltage probe concerning the third embodiment. FIG. 5A is a plan view of the transmission-type and FIG. 5B is a partially enlarged cross-sectional view showing the cross-sectional configuration of the package. As shown in FIGS. 5A and 5B, in an optical voltage probe 50 of the present embodiment, the optical modulator 1 similar to that of the first embodiment is arranged and fixed in a package 51. The optical voltage probe 50 is same as the optical voltage probe 10 of the first embodiment except for the package 51. In the present embodiment, the package 51 is formed by adhering a sheet-shaped metal body 53 formed of permalloy, amorphous metal or the like having high relative magnetic permeability to function as the magnetic shielding material on a surface of a resin package 52 formed of a resin such as polycarbonate and further adhering a sheet-shaped electric wave absorber 54 similar to the electric wave absorber 33 of the second embodiment on the sheet-shaped metal body 53.

Here, the shape of the resin package 52 is same as the package 8 of the first embodiment. The metal body 53 and the electric wave absorber 54 are adhered to an exposed surface of the contact terminal attachment portions 5 and 6 of the resin package 52 and an entire surface of the input/output optical fiber 2 except for the fixing member 13. In the present embodiment, the contact terminal attachment portions 5 and 6 are fixed to the resin package 52.

Similar to the second embodiment, in the present embodiment, the effect of shielding the electric field and the magnetic field with respect to the electromagnetic wave noise can be obtained. Furthermore, the reflection of the electromagnetic wave noise reflected by the package 51 is reduced and the influence of the electromagnetic wave noise to the circuit to be measured can be reduced. Furthermore, in the present embodiment, since the package is made mainly of resin, the weight and cost of the optical voltage probe can be reduced.

As described above, in the present invention, the optical voltage probe capable of measuring the voltage signal of the point to be measured correctly without being affected by the electric field of the surrounding electromagnetic wave noise and the magnetic field of the near field can be obtained. In particular, large electromagnetic wave noise may occur in the device of performing the control using the signals of high power such as a driving circuit of an automobile. Even when the above described circuit is measured, the waveform of the voltage signal between two points to be measured can be correctly measured. In addition, the waveform of the voltage signal can be correctly measured in the electric circuit board arranged near the circuit operating high voltage.

It goes without saying that the present invention is not limited to the above described embodiments and the present invention can be variously modified in accordance with various purposes. For example, the type of the optical modulator to be used is not limited to the reflection type. A transmission-type optical modulator can be also used. In addition, it is not necessary to form the modulation electrode by the sprit electrode. The shape, structure, connection, fixing method and the like of the contact terminal and the contact terminal attachment portions can be selected according to the purpose. In addition, the material of the package, the metal body, the magnetic shielding material and the electric wave absorber can be selected according to the frequency, the shielding performance, the reflection performance and the like of the target electromagnetic wave. The shape and the structure of the package can be arbitrarily selected. For example, in addition to the rectangular parallelepiped shape of the above described embodiment, a cylindrical shape or the like can be also used.

### DESCRIPTION OF THE REFERENCE NUMERALS

1: optical modulator; 2: input/output optical fiber; 3, 4: contact terminal; 5, 6: contact terminal attachment portion; 7: ferrule; 8, 31, 51: package; 8a, 32, 53: metal body; 8b: magnetic shielding material; 9: seat; 10, 30, 50: optical voltage probe; 11, 12: modulation electrode; 13: fixing member; 14: insulator; 15: terminal insertion portion; 16: lead wire; 17: incident light; 18: optical intensity modulation signal; 19: electric component; 21: optical transmission/reception unit; 22: light source; 23: O/E converter; 24: transmission/reception separator; 25: amplifier; 26: output terminal; 27: measuring instrument; 28: input terminal; 29: electric circuit board; 33, 54: electric wave absorber; 41: substrate; 42: branch interference type optical waveguide; 42a:input/output optical waveguide; 42b, 42c: phase shift optical waveguide; 43: buffer layer; 44: modulation electrode portion; 45: light reflecting portion; 46, 47, 48: electrode; 46a, 47a, 47b, 48b: electrode portion; 52: resin package

1. An optical voltage probe comprising:
an optical modulator having at least two modulation electrodes, the optical modulator being configured to modulate an intensity of an incident light depending on a voltage between the two modulation electrodes and output the modulated incident light;
an input optical fiber that is connected with the optical modulator;
an output optical fiber that is connected with the optical modulator;
two first contact terminals or two contact terminal attachment portions to which two second contact terminals can be detachably attached and contacted, the two first contact terminals being connected with the two modulation electrodes and configured to be in contact with points to be measured, the two second contact terminals being connected with the two modulation electrodes and configured to be in contact with the points to be measured; and
a package that houses the optical modulator, a part of the input optical fiber and a part of the output optical fiber, wherein
a voltage signal induced between the two modulation electrodes via the two first contact terminals or the two second contact terminals is converted into an optical intensity modulation signal by the optical modulator and the optical intensity modulation signal is outputted through the output optical fiber,
the package is configured to cover an inside of the package with a metal body for shielding an electric field and a magnetic shielding material for shielding a magnetic field, the magnetic shielding material being arranged inside or outside the metal body, and
the magnetic shielding material is formed of a layered material or a sheet material having a relative magnetic permeability of 1000 or more.

2. An optical voltage probe comprising:
an optical modulator having at least two modulation electrodes, the optical modulator being configured to modulate an intensity of an incident light depending on a voltage between the two modulation electrodes and output the modulated incident light;
an input optical fiber that is connected with the optical modulator;
an output optical fiber that is connected with the optical modulator;
two first contact terminals or two contact terminal attachment portions to which two second contact terminals can be detachably attached and contacted, the two first contact terminals being connected with the two modulation electrodes and configured to be in contact with points to be measured, the two second contact terminals being connected with the two modulation electrodes and configured to be in contact with the points to be measured; and
a package that houses the optical modulator, a part of the input optical fiber and a part of the output optical fiber, wherein
a voltage signal induced between the two modulation electrodes via the two first contact terminals or the two second contact terminals is converted into an optical intensity modulation signal by the optical modulator and the optical intensity modulation signal is outputted through the output optical fiber, and
the package is configured to cover an inside of the package with a metal body having a relative magnetic permeability of 1000 or more for shielding an electric field and a magnetic field.

3. The optical voltage probe according to claim 1, wherein
an electric wave absorber is provided on a surface of the package for reducing a reflection of an electromagnetic wave arrived from an outside of the package and reflected by the package.

4. The optical voltage probe according to claim 2, wherein
an electric wave absorber is provided on a surface of the package for reducing a reflection of an electromagnetic wave arrived from an outside of the package and reflected by the package.

5. The optical voltage probe according to claim 1, wherein
the optical modulator is a branch interference type optical modulator using an optical waveguide formed on a lithium niobate crystal substrate.

6. The optical voltage probe according to claim 2, wherein
the optical modulator is a branch interference type optical modulator using an optical waveguide formed on a lithium niobate crystal substrate.

7. The optical voltage probe according to claim 1, wherein
the optical modulator is a branch interference type optical modulator using an optical waveguide formed on a lithium niobate crystal substrate,
the optical modulator is a reflection type optical modulator where the incident light is reflected inside the optical modulator to change a direction of the incident light, and
the input optical fiber and the output optical fiber are formed by one input/output optical fiber.

8. The optical voltage probe according to claim 2, wherein
the optical modulator is a branch interference type optical modulator using an optical waveguide formed on a lithium niobate crystal substrate,
the optical modulator is a reflection type optical modulator where the incident light is reflected inside the optical modulator to change a direction of the incident light, and
the input optical fiber and the output optical fiber are formed by one input/output optical fiber.
